(19) United States
(12) Patent Application Publication
(10) Pub. No.: US 2010/0285222 A1
(43) Pub. Date: Nov. 11, 2010

(54) Method of Reducing Gaseous Sulfur Components from Indoor Air Caused by Emissions from Construction Materials

(76) Inventors: Jochen Billecke, Bochum (DE); Rüdiger Oberste-Padtberg, Wuppertal (DE); Jõrg Sieksmeier, Essen (DE)

Correspondence Address: ECKERT SEAMANS CHERIN & MELLOTT, 600 GRANT STREET, 44TH FLOOR, PITTSBURGH, PA, 15219, US

(21) Appl. No.: 12/496,326

(22) Filed: Jul. 1, 2009

(30) Foreign Application Priority Data
May 8, 2009 (DE) 10 2009 020 555.1

(51) Int. Cl. B01D 53/40; B05D 3/00; B05D 3/10

(52) U.S. Cl. 427/299; 423/244.07; 427/331

(57) ABSTRACT

In a method for reducing the pollution of buildings with gaseous acidic sulfur compounds, interior building walls, floors, or ceilings are provided with a coating composition containing an alkaline-earth hydroxide in an amount from 5 to 90 wt % with respect to the weight of the coating composition in a binder matrix, and the coating containing calcium hydroxide is allowed to react with the gaseous acidic sulfur compounds to form solid crystalline reaction products. In one embodiment, the coating composition may also contain 1 to 30 wt. % of at least one alkali-metal hydroxide. In another embodiment, the coating composition may also contain 1 to 5 wt. % zinc oxide. One or more diffusion-tight layers may be employed.

### BACKGROUND OF THE INVENTION

1. Field of the Invention

The invention relates to methods for reducing pollution of buildings with gaseous acidic sulfur compounds.

2. Description of the Prior Art

Wallboards and other construction materials based on gypsum can lead to emissions of C2S, H₂S, H2S03, and H₂SO4, if they are produced with industrial residues having residual components of sulfides, sulfites, and sulfates, such as fly ash. These liquid and gaseous compounds are damaging to health and a burden and lead to corrosion on metal parts, such as door frames or air conditioners, for example.

An unpleasant odor can also remain after the boards in question are dismantled, since the previously gaseous compounds can also diffuse into other porous components, such as concrete, wood or plywood, or insulation material.

DE 34 15 210 A 1 discloses a method for desulfurization of flue gas in a furnace installation, in which deacidified raw cement meal is fed to the flue gas as adsorbent. DE 37 16 566 A1 discloses the use of reactive calcium hydroxides in industrial waste-gas scrubbing; the increase in reactivity of calcium hydroxide in particular [[[]]leads[[]]] to deposition of harmful substances from waste gases, in which alkali hydroxides, alkali hydrogen carbonates and/or alkali carbonates, hydrate-forming substances, such as calcium chloride, and hydroxide-forming substances, such as iron oxide, are added to the water required for quenching burned lime. A solution of calcium-hydroxide is known as an agent to precipitate sulfur compounds from flue gases.

Coatings and paints for adsorption of harmful substances in interior rooms are known in principle. DE 100 32 687 A1 discloses a paint for adsorption of typical interior-room harmful substances containing an aqueous mixture of organophilic bentonites or zeolites and silica gel in a mixing ratio of 10:25:1. DE 101 04 341 A1 discloses a coating with adsorbent properties for interior-room surfaces, for example, for adsorption of sulfur dioxide, sulfur trioxide, and hydrogen sulfide, in which activated carbons, diatomaceous earth, zeolites, and/or sulfur in amounts from 0.5 to 20 wt % are contained in the coating as adsorbents. DE 102 51 392 A1 discloses a paint for elimination of odorous and harmful substances with activated carbon as a porous adsorbent.

### SUMMARY OF THE INVENTION

The invention is based on the problem of providing an agent for reducing the odor and harmful-substance load in building interiors from gaseous acidic sulfur compounds, such as C2S, H2S, H2S03, and H2SO4.

This problem is solved in that interior building walls, floors, or ceilings are provided with a coating composition that contains an alkaline-earth hydroxide in an amount from 5 to 90 wt %, with respect to the weight of the coating composition, in a binder matrix and the calcium-hydroxide containing coating is allowed to react with the gaseous acidic sulfur compounds to form solid, crystalline reaction products.

### DESCRIPTION OF THE PREFERRED EMBODIMENTS

It has surprisingly been found that calcium hydroxide has very good binding properties for the sulfur compounds mentioned, even when incorporated in a matrix. Foul-smelling and corrosion-[[ ]]promoting substances, such as C2S, H2S, H2S03, and H2SO4 then react to form sulfides, sulfites, or sulfates of the alkaline earth. They will also react with these hydroxides in mixtures of the above-mentioned sulfur-containing substances. The above-mentioned reactions lead to depletion of the sulfur-containing gaseous substances mentioned in the interior space and thus provide a detectable improvement in indoor air. Alkaline-earth hydroxide compounds have thus far not been used to reduce odor burdens in interior building rooms.

The alkaline-earth hydroxide is contained in a fraction of 5 to 90 wt %, preferably 10 to 40 wt %, with respect to the weight of the composition. The alkaline-earth hydroxide used according to the invention is preferably calcium hydroxide.

The coating composition used according to the invention can also contain preferably 1 to 30 wt % of an alkali-metal hydroxide, with respect to the weight of the composition, in order to further increase the binding ability. Sodium hydroxide is particularly suited for this purpose.

Another advantageous embodiment of the method according to the invention is in a further addition of zinc oxide or zinc hydroxide, because this has high affinity to sulfur compounds. The percentage of these compounds in the coating composition can be 1 to 40 wt %, preferably 3 to 25 wt %, with respect to the weight of the coating composition. The rate of reduction of harmful substances in indoor air is thus increased.

The alkaline-earth hydroxide used as reaction partner according to the invention for harmful substances in interior building rooms is used in a matrix with a construction material. The binder is preferably cement, gypsum, or a construction material mixture containing cement or gypsum. In the case of a construction-material mixer, ordinary fillers and mortar or troweling-compound additives can also be present. The coating composition is present as a powdered solid. The coating composition is used as a plaster, mortar, or troweling compound.

Another advantageous embodiment of the method consists of the fact that before application of the coating composition to the interior surface of the room, a diffusion-tight layer is applied to the interior surface of the room. This serves as a primer for the coating composition used according to the invention. Diffusion-tight layers can be obtained by a reaction of resin coatings, such as coatings from epoxy resin, or polyurethane, also coatings from polymer dispersions, such as acrylate paints.

As an alternative to this, the diffusion-tight layer can also be applied to the hardened troweling compound layer according to the invention. In this way, it is achieved that additional harmful substance emissions from the wallboard, for example, into the building interior are essentially avoided.

The following examples will serve to explain the invention further.

To check the content of hydrogen sulfide in the following examples, a test system from the Drager Co. was used. For the test, a defined gas volume of 100 ml was passed through a corresponding glass test tube by means of a suction pump and made to react with specific reagents. In this case a) test tubes with a scale display from 0.2 to 7 vol % H2S and b) test tubes with a scale display from 2 to 40 vol % H2S were used. In the presence of a corresponding amount of hydrogen sulfide, a color change from light blue to black occurs.

### Example 1

H2S gas in a concentration of 20 vol % is introduced to a closed 2-liter vessel. A hardened mortar fragment produced from a calcium-sulfate-containing binder system (45% CaSO4×Y2H20) with a content of 24% calcium hydroxide, a weight of 34 g, and dimensions of 0.5 cm and 9 cm diameter was additionally introduced to this vessel. After a reaction time between the gas and mortar of 2 hours, the H2S concentration was still 3 vol %; after another 16 hours, the H2S concentration was 0 vol %. After 18 hours, the entire amount of H2S was therefore bonded by the mortar according to the invention.

### Example 2

A disk of sulfide-containing wallboard measuring 200 mm×200 mm×5 mm was placed in a closed air space with a volume of 5 liters. After a dwell time of 24 hours at a relative humidity of 65% and a temperature of 23° C., the H2S content in the air space was 1 vol %. In a parallel experiment, a disk of sulfide-containing wallboard with the same dimensions of 200 mm×200 mm×5 mm is coated with a layer of a calcium sulfate binder system 2 mm thick containing 24% calcium hydroxide and stored under the same conditions in a closed air space with a volume of 5 liters at a relative humidity of 65% at a temperature of 23° C. After 24 hours, no H2S concentration is measurable in this experimental arrangement.

### Example 3 (Comparison)

A hardened mortar fragment, but with 30 wt % Portland cement and 70 wt % quartz sand as filler and a weight of 62 g and the same dimensions as in example 1 is introduced to a closed 2-liter vessel, in which an H2S gas concentration of 20 vol % is set. After 18 hours, the H2S content is still 19 vol %. After 18 hours, only 1 vol % was therefore broken down.

### Example 4

A hardened mortar fragment, but with Portland cement as the main ingredient and a calcium-hydroxide content of 24%, a weight of 58 g, and dimensions of 0.5 cm with a diameter of 9 cm was introduced into a closed 2-liter vessel, in which an H2S concentration of 20 vol % was set. After a reaction time of 2 hours between the H2S gas and the test specimen, the H2S concentration was still 3 vol %, as an example 1. After another 16 hours of reaction time, H2S could no longer be found. After 18 hours, the total amount of H₂S was broken down.

### Example 5 (Comparison)

A hardened mortar fragment containing calcium sulfate as the main ingredient without hydroxide-containing components was introduced to a closed 2-liter vessel as in example 1, with an H2S concentration of 20 vol %. See example 1 for dimensions. After 2 hours, as well as after 18 hours, the H2S content was 20 vol %. Consequently, no H2S was broken down.

### Example 6

A disk of sulfide-containing wallboard measuring 200 mm×200 mm×5 mm was placed in a closed air space with a volume of 5 liters. After a dwell time of 24 hours at a relative humidity of 65% and a temperature of 23° C., the H2S content in this air space was 1 vol %. In a parallel experiment, the same gypsum board was coated with a coating layer 3 mm thick consisting of a calcium-sulfate-containing binder system (45% CaSO4×Y2H20) and 24% calcium hydroxide. After 24 hours no more H₂S could be found in the air space surrounding the test object.

1. A method for reducing pollution of buildings by gaseous acidic sulfur compounds comprising coating at least one of the interior components selected from the group consisting of walls, floors, and ceilings with a coating composition that contains an alkaline-earth hydroxide in an amount from about 5 to 90 wt %, with respect to the weight of the coating compositions in a binder matrix and allowing the coating containing calcium hydroxide to react with the gaseous acidic sulfur compounds to form solid crystalline reaction products.

2. The method claim 1, including employing as said binder matris at least one material selected from the group consisting of a cement, a gypsum-bonded matrix, a troweling compound, and a plaster capable of forming solid crystalline reaction products with said sulfur compounds.

3. The method of claim 1 including the coating composition contains 10 to 40 wt % calcium hydroxide with respect to the weight of the coating composition.

4. The method of claim 1 wherein the alkaline-earth hydroxide is calcium hydroxide.

5. A method according to one of claim 1 including the coating composition contains 1 to 30 wt % of at least one alkali-metal hydroxide with respect to the weight of the coating composition.

6. The method of claim 5 including the coating composition contains 5 to 15 wt % of at least one alkali-metal hydroxide with respect to the weight of the coating composition.

7. The method of claim 1 including the coating composition contains 1 to 5 wt % zinc oxide with respect to the weight of the coating composition.

8. The method of claim 1 including before application of the coating composition to said interior building walls, floors, or ceilings, applying a diffusion-tight layer thereto.

9. The method of claim 1 including a diffusion-tight layer is applied to the applied coating composition.

10. A method for reducing pollution in buildings by gaseous acidic sulfur compounds comprising
coating at least one building interior component selected from the group consisting of walls, floors, and ceilings,
said coating composition containing an alkaline-earth hydroxide in an amount from 5 to 90 wt. % with respect to the weight of the coating composition and 1 to 30 wt. % of an alkali-metal hydroxide crystalline with respect to the weight of the coating component, and
in binder matrix to react with the gaseous acidic sulfur compounds to form solid crystal and reaction compounds.

11. The method of claim 10 including
employing calcium hydroxide as said alkaline-earth hydroxide.

12. The method of claim 11 including
the coating composition employing 5 to 15 wt. % of said alkali-metal hydroxide with respect to the weight of the coating composition.

13. The method of claim 11 including
the coating composition employing 1 to 5 wt. % zinc oxide with respect to the weight of the coating composition.

14. The method of claim 10 including
prior to applying said coating composition, applying a diffusion-tight layer to at least one of said building walls, floors, and ceilings.

15. The method of claim 10 including
after applying said coating composition, applying a diffusion-tight layer thereover.
